(19) United States
(12) Patent Application Publication
(10) Pub. No.: US 2010/0130122 A1
(43) Pub. Date: May 27, 2010

(54) APPARATUS AND METHOD FOR PERFORMING POWER MANAGMENT IN A RECEIVER

(75) Inventors: Avinash Sridhar, Plainsboro, NY (US); David Anthony Campana, Princeton, NJ (US); Jill MacDonald Boyce, Manalapan, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing LLC, Princeton, NJ (US)

(21) Appl. No.: 12/451,577

(22) PCT Filed: Jun. 1, 2007
(86) PCT No.: PCT/US2007/013058

§ 371 Date: Nov. 19, 2009

(51) Int. Cl. H04H 20/71; H04N 5/445; H04B 1/16

(52) U.S. Cl. 455/3.01; 725/39; 455/343.1

(57) ABSTRACT

A Digital Video Broadcasting-Handheld (DVB-H) system comprises a head-end and at least one receiver. The head-end uses the File Delivery over Unidirectional Transport (FLUTE) protocol for transmitting an electronic service guide (ESG) and content to the receiver. The receiver determines a time delay for receiving content as a function of a value of a PublishedStartTime parameter from the ESG and the actual time the receiver receives the content. Using this time delay, the receiver forms a time estimate for receiving selected content as a function of a value of a PublishedStartTime parameter from the ESG for the selected content and the determined time delay. The receiver then performs power, management such that during those intervals of time that the receiver is not expected to receive the selected content the receiver can reduce power.

### BACKGROUND OF THE INVENTION

The present invention generally relates to communications systems and, more particularly, to power management in a communications device such as, but not limited to, a mobile device, battery-powered device, etc.

Today, mobile devices are everywhere—from MP3 players to personal digital assistants to cellular telephones to mobile televisions (TVs). Unfortunately, a mobile device typically has limitations on computational resources and/or power. In this regard, an Internet Protocol (IP) Datacast over Digital Video Broadcasting-Handheld (DVB-H) system is an end-to-end broadcast system for delivery of any type of file and service using IP-based, mechanisms that is optimized for such devices. For example, see ETSI EN 302 304 V1:1.1 (2004-11) “Digital Video Broadcasting (DVB); Transmission System for Handheld Terminals (DVB-H)”; ETSI EN. 300 468 V1.7.1 (2006-05) “Digital Video Broadcasting (DVB); Specification for Service Information (SI) in DVB systems”; ETSI TS 102 472 V1.1.1 (2006-06) “Digital Video Broadcasting (DVB); IP Datacast over DVB-H: Content Delivery Protocols”; and ETSI TS 102 471 V1.1.1 (2006-04) “Digital Video Broadcasting (DVB); IP Datacast over DVB-H: Electronic Service Guide (ESG)”. An example of an IP Datacast over DVB-H system as known in the art is shown in FIG. 1. In FIG. 1, a head-end 10 (also referred to herein as a “sender”) broadcasts, via antenna 35, a DVB-H signal 36 to one, or more, receiving devices (also referred to herein as “clients” or “receivers”) as represented by receiver 90. The DVB-H signal 36 conveys the IP Datacasts to the clients. Receiver 90 receives DVB-H signal 36, via an antenna (not shown), for recovery therefrom of the IP Datacasts. The system of FIG. 1 is representative of a unidirectional network.

The above-described IP Datacasts are used to provide content-based services by distributing files such as an electronic service guide (ESG) and content files. In the context of FIG. 1, a content-based service can be real-time content, e.g., a television (TV) program, or file-based content, e.g., short-form content, which is shorter than a typical TV program. The ESG provides the user with an ability to select content-based services and enable the receiver to recover the selected content. In this regard, an ESG typically includes descriptive data, or metadata, about the content (also referred to herein as an event), such as the name of the TV program, a synopsis, actors, director, etc., as well as the scheduled time, date, duration and channel for broadcast. A user associated with receiver 90 can receive content that is referred to by the ESG by tuning receiver 90 to the appropriate channel identified by the ESG. It should be noted that in the case of real-time content, e.g., a TV broadcast, the ESG includes a Session Description Protocol (SDP) file (e.g., see M. Handley, V. Jacobson, April 1998—“RFC 2327—SDP: Session Description Protocol). The SDP file includes additional information that enables receiver 90 to tune into selected broadcast content.

With respect to file-based content, head-end 10 of FIG. 1 distributes files using the File Delivery over Unidirectional Transport (FLUTE) protocol (e.g., see T. Paila, M. Luby, V. Roca, R. Walsh, “RFC 3926—FLUTE—File Delivery over Unidirectional Transport,” October 2004). The FLUTE protocol is used to transmit files, or data, over unidirectional networks and provides for multicast file delivery. In this example, it is also assumed that head-end 10 uses the Asynchronous Layered Coding (ALC) protocol (e.g., see Luby, M., Gemmell, J., Vicisano, L., Rizzo, L., and J. Crowcroft, “Asynchronous Layered Coding (ALC) Protocol Instantiation”, RFC 3450, December 2002) as the basic transport for FLUTE. The ALC protocol is designed for delivery of arbitrary binary objects. It is especially suitable for massively scalable, unidirectional, multicast distribution.

Turning briefly to FIG. 2, the transmission of file-based content using FLUTE is illustrated in the context of head-end 10 broadcasting an ESG. Transmission of other file-based content is similar and not described herein. Head-end 10 comprises ESG generator 15, FLUTE sender 20, IP encapsulator 25 and DVB-H modulator 30. ESG generator 15 provides an ESG to FLUTE sender 20, which formats the ESG in accordance with FLUTE over ALC and provides the resulting ALC packets conveying the FLUTE files to IP encapsulator 25 for encapsulation within IP packets as known in the art. The resulting IP packets are provided to DVB-H modulator 30 for transmission to one, or more, receiving devices as illustrated in FIG. 1. A receiver tunes to a particular FLUTE channel (e.g., IP address and port number) to recover the ESG for use in the receiver.

As noted above, a receiver may have power limitations, e.g., battery life. In addition, a receiver in a broadcast network may only be receiving particular, or selected, file-based content at particular times. At other times, the receiver—while being fully powered up—is not processing any other content transmitted by the broadcast network. As such, it would be beneficial if the FLUTE sender (e.g., FLUTE sender 20 of head-end 10 of FIG. 2) and the FLUTE receiver (e.g., the FLUTE receiver portion (not shown) of receiver 90 of FIG. 1) were time synchronized such that the receiver could reduce power during those time intervals when the selected information is not being received so as to increase the battery life of the receiver. One approach for performing time synchronization is shown in FIG. 3. In particular, in FIG. 3, timing synchronization is performed between head-end 10 and receiver 90 via a Network Time Protocol (NTP) server 45. In this case, FLUTE sender 20 (of head-end 10) provides a Time and Date Table (TDT) (e.g., see the above-referenced ETSI EN 300 468 V1.7.1) that includes an NTP timestamp from NTP server 45. Head-end 10 broadcasts the TDT in DVB-H signal 36. Receiver 90 then uses just the received NTP time stamp to look for selected content at particular times. Alternatively, head-end 10 can provide the NTP time stamp to receiver 90 in Real-time Transport Control Protocol (RTCP) Sender Reports that are included in a Live Service broadcast (e.g., see Audio-Video Transport Working Group, H. Schulzrinne, G M D Fokus S. Casner, Precept Software, Inc., R. Frederick, Xerox Palo Alto Research Center, V. Jacobson, January 1996—“RFC 1889 RTP: A Transport Protocol for Real-Time Applications).

### SUMMARY OF THE INVENTION

We have observed that performing timing synchronization by using an NTP timestamp as described above is not always adequate for performing power management in a receiver. In particular, the above-described approach does not take into account additional time delays. In other words, the use of an NTP timestamp does not provide the receiver with the actual time that selected information will be received at the receiver. This synchronization problem may be further compounded if the receiver is getting the NTP timestamp from an RTCP sender report since the RTCP sender report is not available if the receiver is not tuned to a live service broadcast.

However, we have realized that it is possible for a receiver to determine an estimate of any time delays from sender to receiver that take into account parameters like distance, interference etc. for that receiver. In particular, and in accordance with the principles of the invention, a receiver determines a time delay as a function of a transmission time and a reception time when receiving an event; and determines a time estimate for receiving a selected event as a function of the time delay.

In an illustrative embodiment of the invention, a Digital Video Broadcasting-Handheld (DVB-H) system comprises a head-end and at least one receiver. The head-end uses the File Delivery over Unidirectional Transport (FLUTE) protocol for transmitting an electronic service guide (ESG) and content to the receiver. The receiver determines a time delay for receiving content as a function of a value of a PublishedStartTime parameter from the ESG and the actual time the receiver receives the content. Using this time delay, the receiver forms a time estimate for receiving selected content as a function of a value of a PublishedStartTime parameter from the ESG for the selected content and the determined time delay.

In another embodiment of the inventive concept, the receiver then performs Power management such that during those intervals of time that the receiver is not expected to receive the selected content the receiver can reduce power.

In view of the above, and as will be apparent from reading the detailed description, other embodiments and features are also possible and fall within the principles of the invention.

### BRIEF DESCRIPTION OF THE DRAWINGS

FIGS. 1-3 shows a prior art Internet Protocol (IP) Datacast over Digital Video Broadcasting-Handheld (DVB-H) system;

FIG. 4 shows file-based content transmission and an associated fragment of an ESG for the system of FIGS. 1-3;

FIG. 5 illustrates time delays in accordance with the principles of the invention;

FIG. 6 shows an illustrative embodiment of a system in accordance with the principles of the invention;

FIGS. 7 and 8 show illustrative flow charts for use in a receiver in accordance with the principles of the invention;

FIG. 9 illustrates the use of an ESG fragment and an FDT in accordance with the principles of the invention;

FIG. 10 shows another illustrative flow chart in accordance with the principles of the invention;

FIG. 11 shows in illustrative actual start time table for selected content in accordance with the principles of the invention;

FIG. 12 shows an example of power management in accordance with the principles of the invention;

FIG. 13 shows another illustrative flow chart in accordance with the principles of the invention; and

FIGS. 14 and 15 show illustrative embodiments of a receiver in accordance with the principles of the invention.

### DETAILED DESCRIPTION

Other than the inventive concept, the elements shown in the figures are well known and will not be described In detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

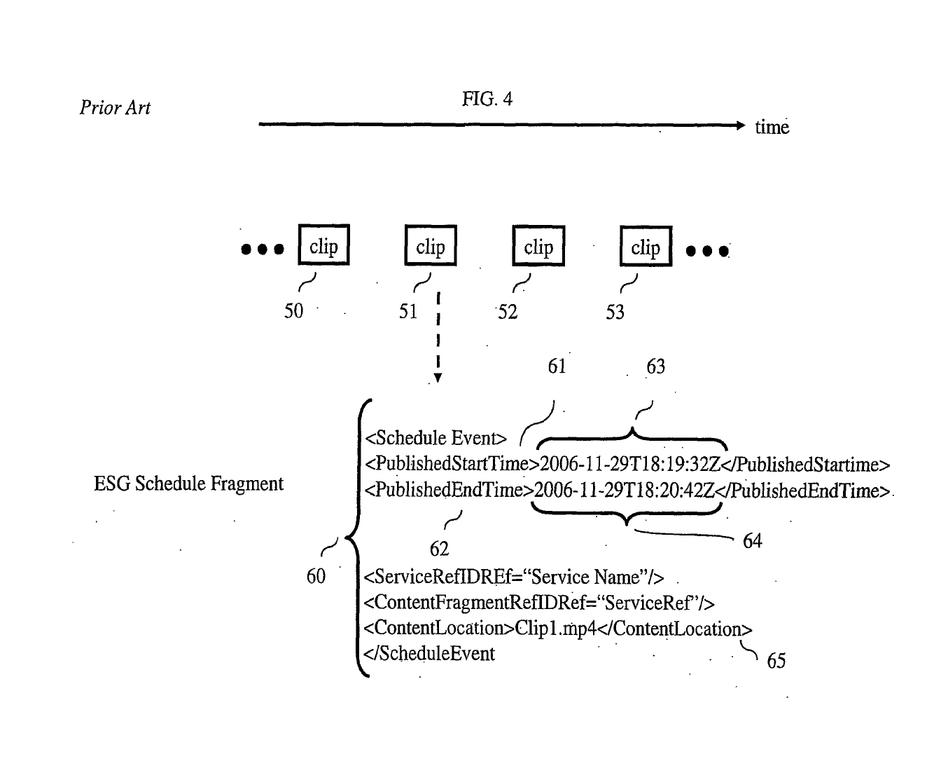

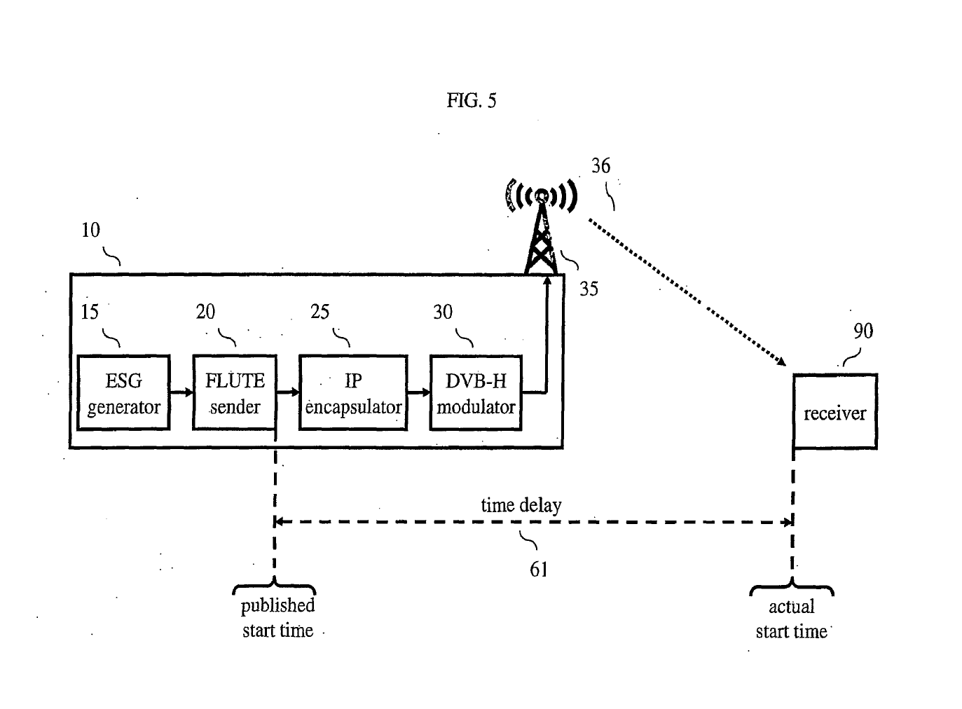

As described earlier, we have observed that performing timing synchronization by using an NTP timestamp as described above is not always adequate for performing power management in a receiver. In particular, the above-described NTP timestamp approach does not take into account additional time delays. This is further illustrated in FIGS. 4 and 5 in the context of file-based content transmission in DVB-H. In FIG. 4, file-based content transmission in DVB-H comprises a number of events (also referred to herein as clips) as represented by clips 50, 51, 52 and 53. Each clip may comprise a number of packets, but this is not relevant to the inventive concept. The ESG associates each clip with a start time, an end time and identifies the associated content file in the corresponding FLUTE session. This is illustrated in FIG. 4 for a fragment 60 of an ESG (ESG fragment 60) associated with clip 51. For simplicity other ESG data is not shown. As shown in FIG. 4, ESG fragment 60 includes a ContentLocation parameter 65, a PublishedStartTime parameter 61 as well as a PublishedEndTime parameter 62 associated with clip 51. In this example, the associated content file in the corresponding FLUTE session is “Clip1.mp4”. The actual values for the PublishedStartTime and PublishedEndTime, 63 and 64, respectively, are in Coordinated Universal Time (UTC) units. The value for the PublishedStartTime is the time that the FLUTE sender will actually start transmitting the files, i.e., the time at which the clip is handed off from the FLUTE sender to the next block in the system chain. This is further illustrated in FIG. 5 for a DVB-H system, i.e., the value for the PublishedStartTime is the time that FLUTE sender 20 hands off the clip to IP encapsulator 25. However, it should be noted that there is an additional time delay from when the data packets leave the FLUTE sender till they actually reach the client via any intermediate network, which includes wired or wireless, unidirectional or bidirectional networks. This is also illustrated in FIG. 5 in the context of the DVB-H system by time delay 61. Without information about this time delay, the receiver may be unable to accurately estimate a content broadcast reception time and hence will not be able to correctly predict the correct time at which to perform power management. The earlier-described NTP timestamp approach to performing timing synchronization does not take into account this time delay. Thus, use of only the NTP timestamp does not provide receiver 90 with the actual time that the content reaches receiver 90 in all situations. Indeed, as noted above, the synchronization problem may be further compounded if the receiver is getting the NTP timestamp from an RTCP sender report since an RTCP sender report is not always available (e.g., if the receiver is not tuned to a live service broadcast).

However, we have realized that it is possible for a receiver to determine an estimate of any time delays from sender to receiver that take into account parameters like distance, interference etc. for that receiver. In particular, and in accordance with the principles of the invention, a receiver determines a time delay as a function of a transmission time and a reception time when receiving an event; and determines a time estimate for receiving a selected event as a function of the time delay. As described herein, a transmission time refers to, e.g., a start time, an end time, etc.; and a reception time refers to, e.g., a time of arrival, time of completion, etc.

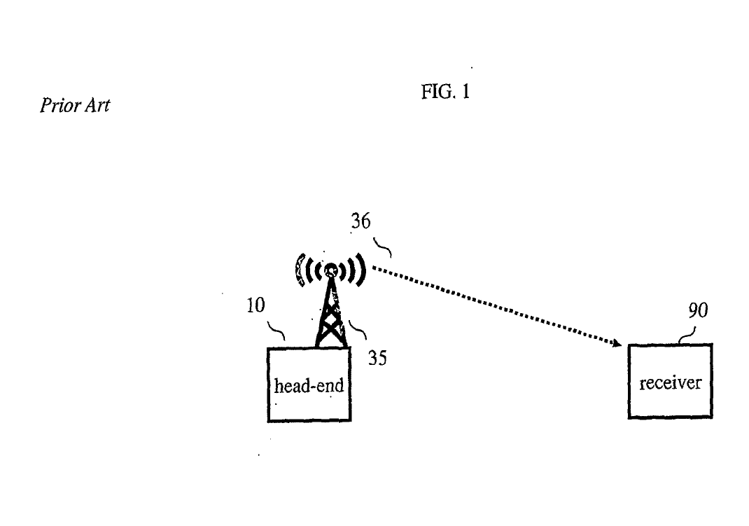

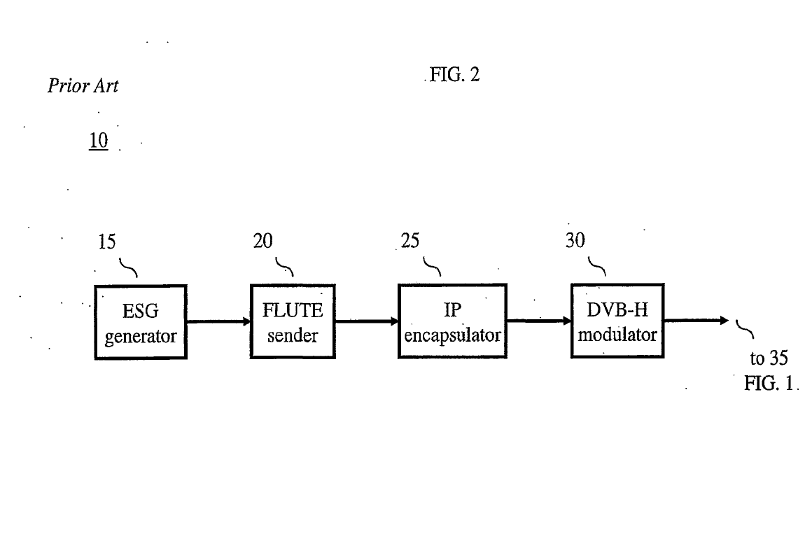

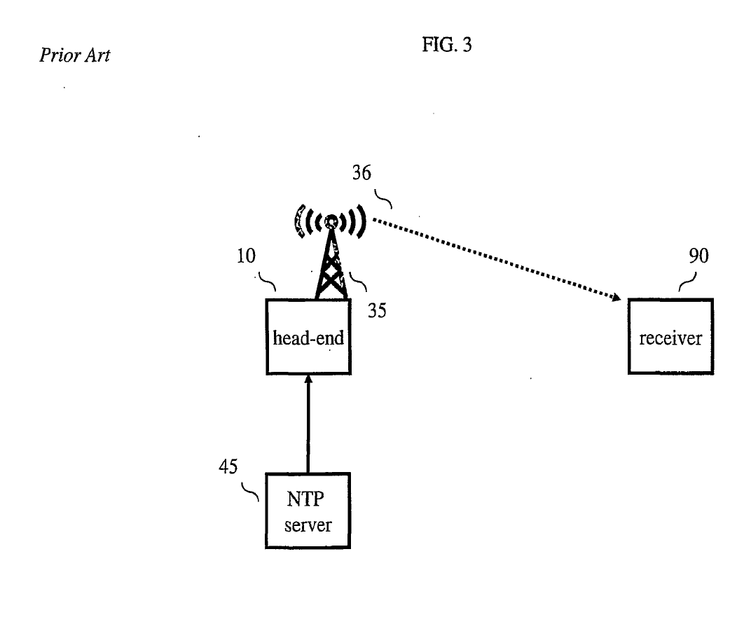

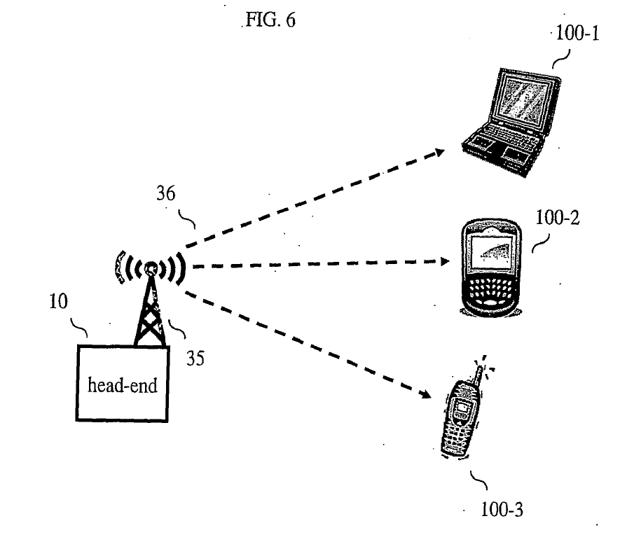

Turning now to FIG. 6, an illustrative system in accordance with the principles of the invention is shown. For the purposes of this example, and other than the inventive concept, it is assumed that the system shown in FIG. 6 is an IP Datacast over DVB-H system similar to that described in FIG. 1. In this context, a head-end 10 broadcasts, via antenna 35, a DVB-H signal 36 for broadcasting IP Datacasts to one, or more, receiving devices (also referred to herein as “clients” or “receivers”) as represented by any one of laptop computer 20-1, personal digital assistant (PDA) 20-2 and cellular telephone 20-3, each of which are assumed to be configured to receive a DVB-H signal for recovery therefrom of the broadcast IP Datacasts for real-time content and file-based content. The system of FIG. 6 is representative of a unidirectional network. However, the inventive concept is not so limited. As described below, each client determines a time estimate for receiving selected information; and performs power management as a function of the determined time estimate.

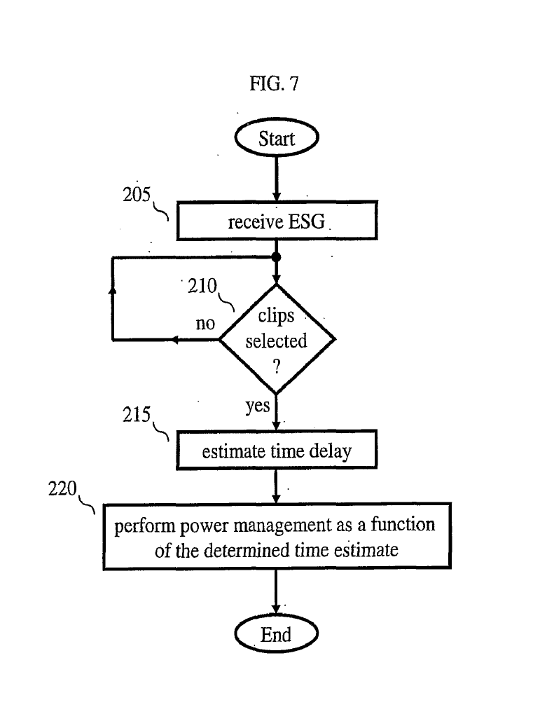

Referring now to FIG. 7, an illustrative flow chart for use in a receiving device (e.g., 20-1, 20-2 or 20-3) in accordance with the principles of the invention is shown. For simplicity, the inventive concept is described in the context of file-based content transmission, but the inventive concept is not so limited. In step 205, the receiving device receives an ESG. The ESG includes a list of file-based content events (clips). In step 210, the receiver determines if any of the clips listed in the received ESG have been selected to be received. The selection of clips can be performed in any number of ways. For example, the user can view the ESG on a display of the receiver and manually select clips for reception. Alternatively, the receiver can store a profile in a memory (not shown) that represents the viewing habits of the user wherein the receiver automatically selects those clips currently listed in the ESG that are tagged with the same keywords as found in the profile. The profile may be set up by the user and/or created by the receiver based on previously received clips. After one, or more, clips have been selected, the receiver estimates a time delay in step 215. Then, in step 220, the receiver performs power management as a function of the determined estimate of the time delay. It should be noted that, for simplicity, error conditions are not shown in the flow charts described herein. For example, if no clips are selected in step 210 for a given period of time the receiver may power-down due to lack of activity.

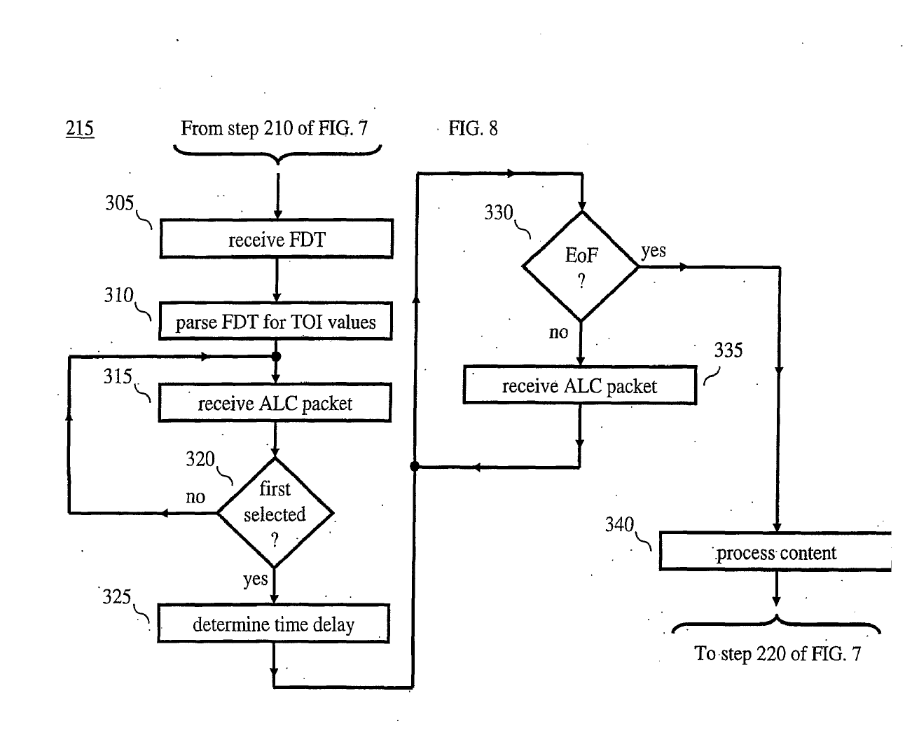

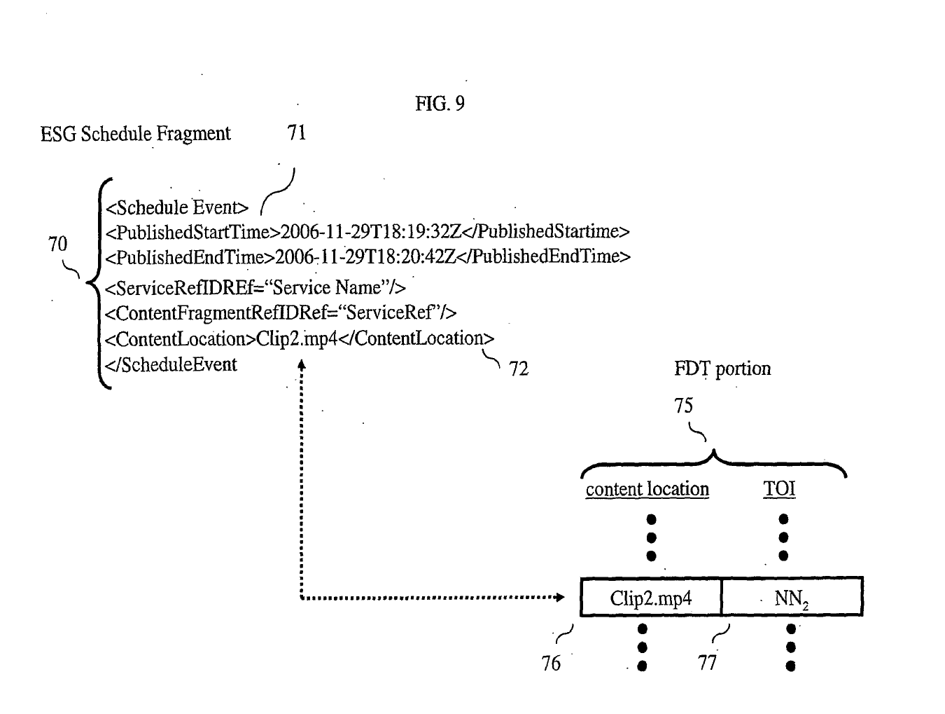

An illustrative flow chart for estimating the time delay in step 215 of FIG. 7 is shown in FIG. 8. This example for estimating the time delay makes use of properties of the FLUTE and ALC protocols. However, the inventive concept is not so limited and other methods of estimating a time delay may be used. The FLUTE-based IP Datacasts include a File Description Table (FDT) for describing attributes of the files being transmitted. In this example, it is assumed that the receiver receives an FDT, in step 305, before transmission of the associated file-based content. Of particular note are the following FDT fields: “Content-Location”, which conveys the name of the file and “Transport Object Identifier (TOI)”, which conveys a unique number that is associated with the file for the scope of the FLUTE session. In step 310, the receiver parses the received FDT for TOT values for the selected content from the ESG. In particular, for each selected content, the receiver identifies the name of the file from the corresponding ContentLocation parameter of the ESG fragment for the selected content (e.g., ContentLocation parameter 65 of FIG. 4) and identifies the associated TOI value for the corresponding file name in the received FDT. This is illustrated in FIG. 9. In FIG. 9, an ESG fragment 70 is associated with selected content, where the name of the selected content “Clip2.mp4” is shown as the value for the ContentLocation parameter 72 of ESG fragment 70. A portion 75 of a received FDT is also shown. As can be observed from FIG. 9, the receiver locates the corresponding file in the received FDT by parsing values of content-location parameter 76 of the FDT to locate the selected file and then determining the associated TOT value from the TOT parameter 77 of the FDT. In this example, the receiver would determine that the selected file “Clip2.mp4” has a TOI value of NN₂, which is an integer value.

Returning to FIG. 8, after parsing the FDT the receiver waits to receive an ALC packet conveying any selected file-based content. Each ALC packet consists of file packets and their associated TOI. Illustratively, the receiver uses the TOT values for the selected content from step 310 to detect when actual reception of the corresponding filed-based content starts. This is shown in steps 315 and 320 of FIG. 8. In particular, upon receiving an ALC packet in step 315, the receiver checks, in step 320, if the TOI value of the received ALC packet corresponds to a TOI value for selected content. If the TOI value of the received ALC packet does not correspond to selected content then the receiver again performs steps 315 and 320 for the next received ALC packet. However, once the receiver detects a TOI value in the received ALC packet corresponding to a TOI value for selected content (e.g., NN₂ associated with “clip2.mp4”), the receiver determines that actual reception of selected content has started and performs step 325 to determine a time delay for the selected content.

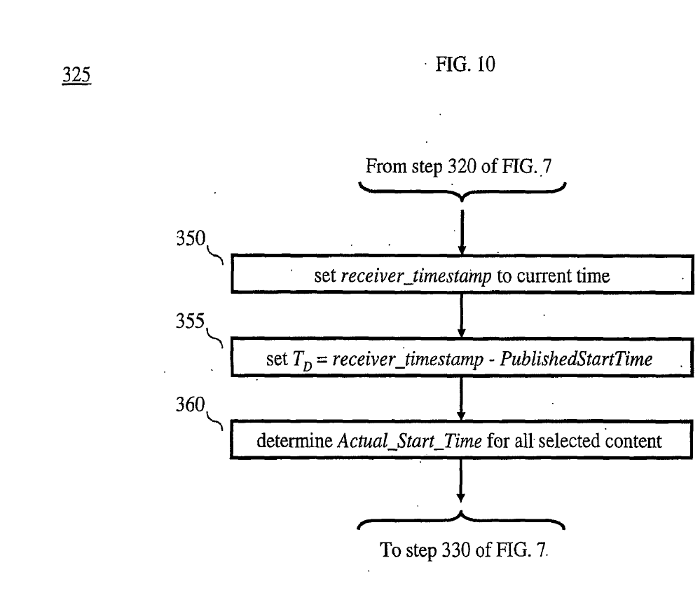

Referring now to FIG. 10, an illustrative flow chart for determining the time delay in step 325 is shown. In step 350, the receiver determines the current time, e.g., from a local clock of the receiver. This current time value is referred to herein as the receiver_timestamp (or reception time). The value for the receiver_timestamp represents the actual start time of receipt of the selected content. In step 355, the receiver determines the time delay from:

T_{D}=receiver_timestamp−PublishedStartTime; (1)

where the parameter T_{D} represents the estimated time delay, and the value for PublishedStartTime is taken from the corresponding ESG fragment for the received selected content (e.g., parameter 71 of ESG fragment 70 for “clip2.mp4”). Once the receiver estimates the time in step 355, the receiver can now estimate the actual start time for delivery of all selected content. In particular, in step 360, for each selected content, the receiver determines:

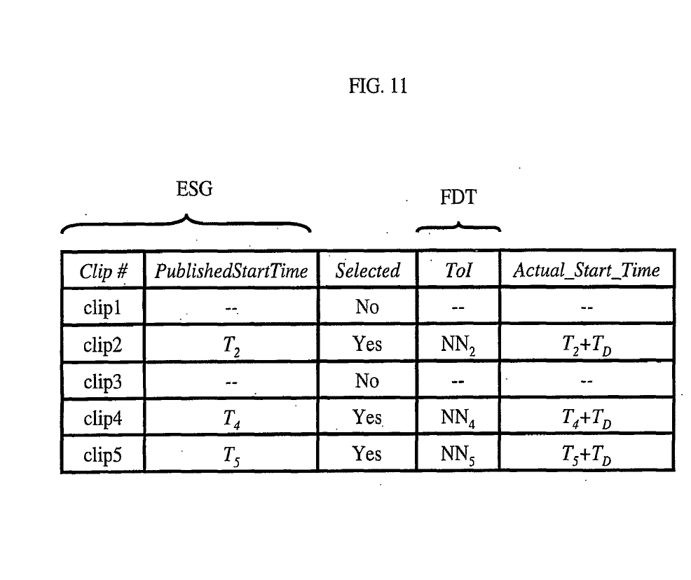

Actual_Start_Time =PublishedStartTime+T_{D}; (2)

where the value for the PublishedStartTime is taken from the associated ESG fragment for each selected content. As a result, the receiver builds an actual start time table as illustrated in FIG. 11 for all selected content indicating their actual start times. In this example, it is assumed that a received ESG indicates five clips are available: clip1, clip2, clip3, clip4 and clip5, and that clip2, clip4 and clip5 have been selected to be received by the receiver (e.g., step 210 of FIG. 7). For each selected clip, associated values for the PublishedStartTime are extracted from the corresponding ESG fragments, e.g., times T₂, T₄ and T₅, for clip2, clip4 and clip5, respectively. Similarly, corresponding TOT values are extracted from the FDT (e.g., step 310 of FIG. 8), e.g., NN₂, NN₄ and NN₅. Finally, the actual start times for receiving the selected content are computed from equation (2). Returning to FIG. 8, the receiver continues to receive ALC packets for the selected content currently being received in steps 330 and 335 until an end of file (EOF) is detected in step 330. Upon detection of an EOF, the receiver processes the received content in step 340. It should be noted that clip2 is included in the table of FIG. 11 for completeness. As described in the following paragraph, for this example clip2 is used to determine the time delay, T_{D}. As such, it is not necessary to determine the actual start time for clip2. However, and in accordance with the principles of the invention, other content, even unselected content such as clip1, can be used to determine the time delay T_{D}.

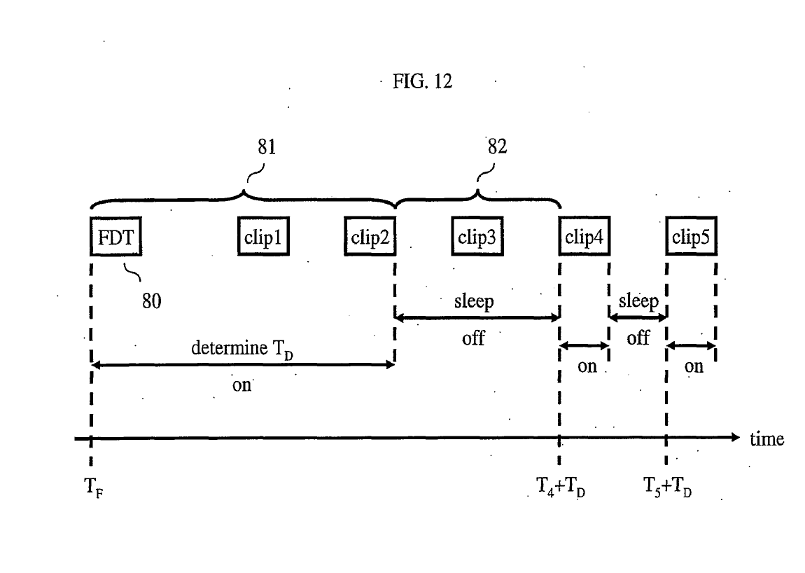

As a result of the above-described process, an actual start time value is determined for each selected content that takes into account network delays between the sender and the receiver. Returning to FIG. 7, the receiver performs power management in step 220 as a function of the determined time estimate. Therefore, and in accordance with the principles of the invention, all FLUTE channels associated with selected content can now be switched on only when needed to receive the selected content. This is illustrated in FIG. 12 for the selected clips shown in the table of FIG. 11. For example, in time interval 81, the receiver is “on” to receive FDT 80 and determine the time delay, T_{D}. In particular, at time T_{F}, the receiver receives and parses a received FDT 80 (steps 305 and 310 of FIG. 8). The receiver then processes received ALC packets looking for selected content to determine a time delay. The first clip, clip1, is ignored by the receiver since clip1 is not selected content as indicated by the received TOI value of clip1. However, upon detecting at the start of clip2 that clip2 is selected content by the received TOI value of clip2, the receiver estimates a value for T_{D}, determines the actual start times for all selected content as described above, and processes the received ALC packets for clip2. As a result, after receiving clip2, that portion of the receiver associated with processing the FLUTE channels for file-based content can now be turned “off”, or “sleep”, in time interval 82 until it is time to start receiving the next selected content, clip4, etc. Thus, and as can be observed from FIG. 12, portions of the receiver can sleep until it is time to actually receive selected content. This frees the receiver from wasting power by having to keep all FLUTE channels open at all times.

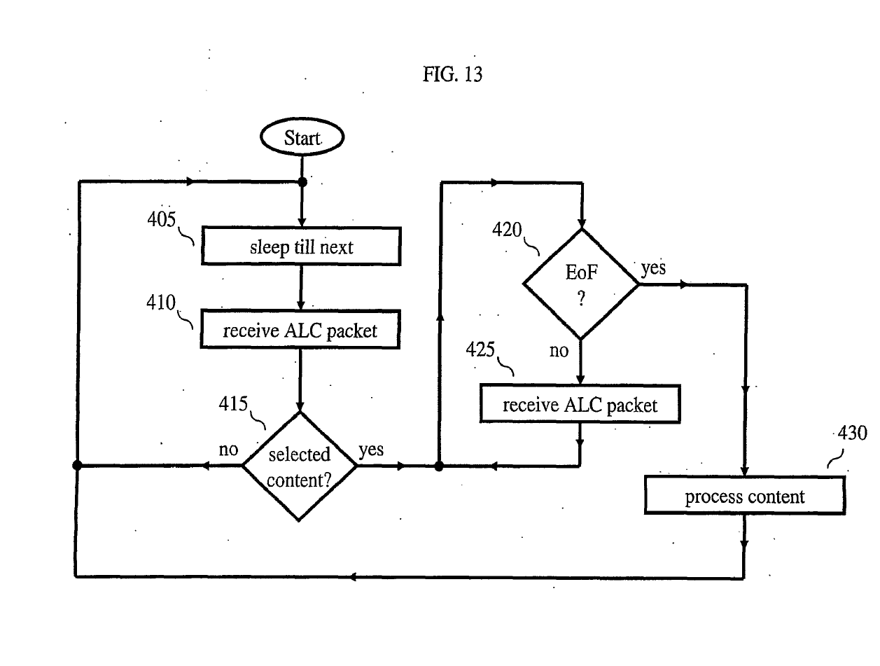

An illustrative flow chart for performing power management in step 220 of FIG. 7 in accordance with the principles of the invention is shown in FIG. 13. After having determined the actual start times for selected content—and, in the process, receiving the first selected content—the receiver sleeps till the actual start time of the next selected content in step 405. When it is time to receive the selected content, the receiver wakes up and receives an ALC packet in step 410. In step 415, the receiver checks the TOI value to determine if this is selected content. If this is not the selected content, the receiver returns to step 405 and sleeps till the actual start time of the next selected content. However, if this is selected content, the receiver continues to receive ALC packets looking for an EOF as shown in steps 420 and 425. Upon detection of an EOF, the receiver processes the received content in step 430. The receiver then returns to step 405 and sleeps till the actual start time of the next selected content.

As noted above, one way the receiver can reduce power is to turn on and off FLUTE channel reception. In this case, the receiver tunes out any IP packets associated with the FLUTE channel and hence eliminates any extra processing for unselected content. However, the receiver can reduce power consumption in other ways in accordance with the principles of the invention. For example, the DVB-H radio receiver itself can be toggled between on and off. This would free the receiver of using power to run the radio receiver during those times when unselected content is being received.

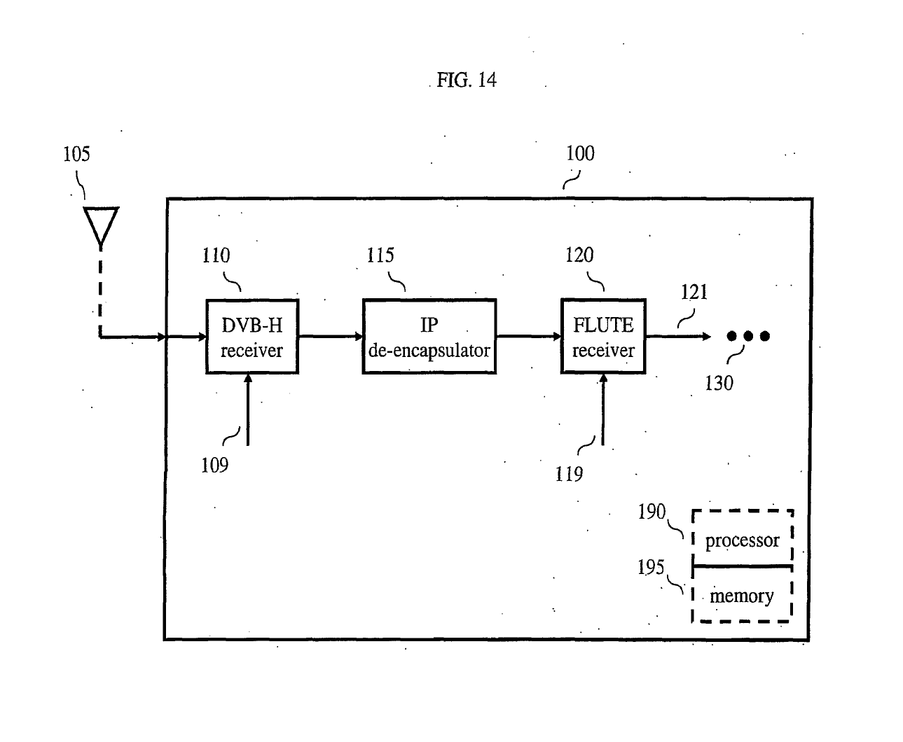

Referring now to FIG. 14, an illustrative embodiment of a receiver 100 in accordance with the principles of the invention is shown. Only that portion of receiver 100 relevant to the inventive concept is shown. Receiver 100 is representative of any processor-based platform, e.g., a PC, a personal digital assistant (PDA), a cellular telephone, a mobile digital television (DTV), etc. In this regard, receiver 100 includes one, or more, processors and associated memory as represented by processor 190 and memory 195 shown in the form of dashed boxes in FIG. 14. In this context, computer programs, or software, as represented by the earlier-described flow charts of FIGS. 7, 8, 10 and 13, are stored in memory 195 for execution by processor 190. The latter is representative of one, or more, stored-program control processors and these do not have to be dedicated to the receiver function, e.g., processor 190 may also control other functions of receiver 100. Memory 195 is representative of any storage device, e.g., random-access memory (RAM), read-only memory (ROM), etc.; may be internal and/or external to receiver 15; and is volatile and/or non-volatile as necessary. Receiver 100 comprises DVB-H receiver 110, IF de-encapsulator 115 and FLUTE receiver 120. Any or all of these components may be implemented in software as represented by processor 190 and memory 195. DVB-H receiver 110 receives DVB-H signal 36 (of FIG. 6) via antenna 105 and provides a demodulated signal to IP de-encapsulator 115. The latter provides ALC packets to FLUTE receiver 120, which recovers content as represented by signal 121. This content may be further processed by receiver 100 as known in the art (as represented by ellipses 130). As described above, and in accordance with the principles of the invention, processor 190 estimates a time delay and performs power management. In this example, FLUTE receiver 120 and DVB-H receiver 110 are powered on, and off, by processor 190 as represented by control signals 109 and 119 such that at least for some of the unselected content receiver 100 operates at reduced power.

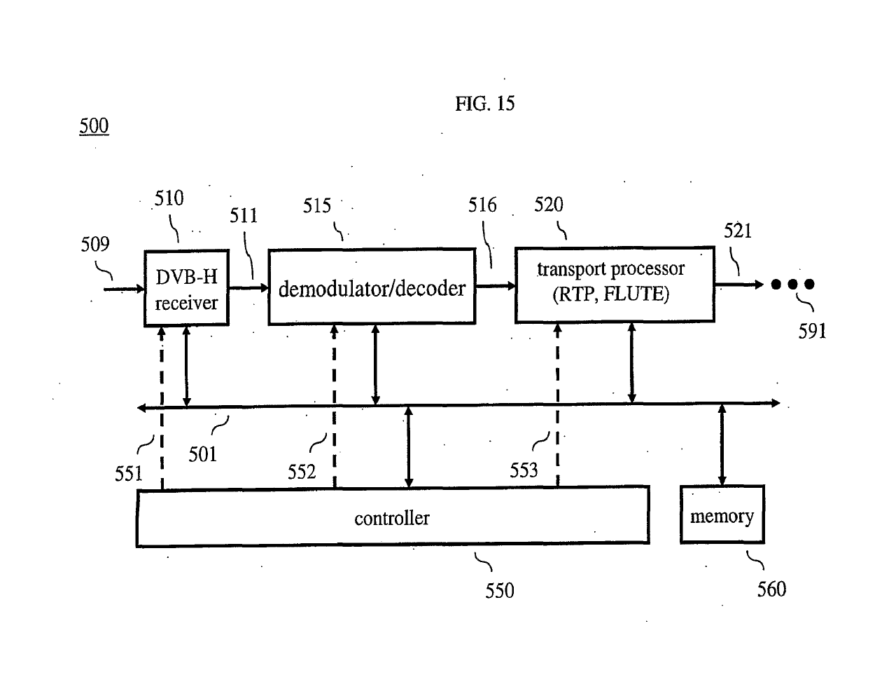

Another illustrative embodiment of a receiver 500 in accordance with the principles of the invention is shown in FIG. 15. Only that portion of receiver 500 relevant to the inventive concept is shown. Receiver 500 includes DVB-H receiver 510, demodulator/decoder 515, transport processor 520, controller 550 and memory 560. It should be noted that other components of a receiver, such as an analog-to-digital converter, front-end filter, etc., are not shown for simplicity. Both transport processor 520 and controller 550 are each representative of one or more microprocessors and/or digital signal processors (DSPs) and may include memory for executing programs and storing data. In this regard, memory 560 is representative of memory in receiver 500 and includes, e.g., any memory of transport processor 520 and/or controller 550. An illustrative bidirectional data and control bus 501 couples various ones of the elements of receiver 500 together as shown. Bus 501 is merely representative, e.g., individual signals (in a parallel and/or serial form) may be used, etc., for conveying data and control signaling between the elements of receiver 500. DVB-H receiver 510 receives a DVB-H signal 509 and provides a down-converted DVB-H signal 511 to demodulator/decoder 515. The latter performs demodulation and decoding of signal 511 and provides a decoded signal 516 to transport processor 520. Transport processor 520 is a packet processor and implements both a real-time protocol and FLUTE/ALC protocol stack to recover either real-time content or file-based content in accordance with DVB-H. Transport processor 520 provides content as represented by content signal 521 to appropriate subsequent circuitry (as represented by ellipses 591). Controller 550 controls transport processor 520, via bus 501, in accordance with the above-described flow charts to recover ESG and FTD information; and for determining the above-described receiver_time_stamp for use in estimating a time delay, T_{D}, and for constructing an actual start time table as illustrated in FIG. 11 for storage in memory 560. Controller 560 performs power management of transport processor 520, DVB-H receiver 510 and demodulator/decoder 515 in accordance with the principles of the invention via controls signals 551, 552 and 553 (via bus 501).

As described above, the inventive concept enables a receiver to estimate receiver-specific time delays that take into account parameters like distance, interference etc. for that receiver. In addition, and in accordance with the principles of the invention, the estimate of the time delay represented by equation (1) can be further refined. For example, every time the receiver powers up to receive selected content, the receiver can update the value for T_{D} based on the timestamp of the currently received selected content. In this regard, the time delay can be estimated over a period of time from a statistical function operating on the difference between the published start time and the reception time. The statistical functions can include standard deviation from the mean of the collected time delay values, averaging of the time delay values, linear and non-linear correlation of the time delay values. The time delay sample points also provide the ability for the receiver to use modeling techniques to make the estimation more efficient. These modeling techniques can include modified or unmodified Gaussian curves, Laplacian curves, and Chi-squared models. In addition, since an ESG fragment also includes a PublishedEndTime field, the receiver can also estimate the time delay by recording the completion time, i.e., the time when the last ALC packet for the received content is received, as the actual end time and comparing the actual end time against the PublishedEndTime in the associated ESG fragment.

It should be noted that other variations for determining a time delay are also possible. In particular, in the description of FIG. 8, it was assumed that the receiver receives an FDT before transmission of the actual content. However, it should be noted that a DVB-H system does not require that an FDT be sent before transmission of the actual content. For example, an FDT could be sent at the end of the content broadcast or asynchronously in a different time period altogether. In such cases, the receiver will receive the selected content without knowledge of file attributes. Nevertheless, the receiver can still determine a time estimate in accordance with the principles of the invention. For example, the receiver can refer to the received ESG to determine content next scheduled for broadcast and use the first received ALC packet of this content to estimate the time delay, as described above, even if this content was not selected content.

In view of the above, and in accordance with the principles of the invention, a receiver performs power management by reducing power during those times when selected content is not being receiver. It should be noted that although the inventive concept was illustrated in the context of a unicast DVB-H system having mobile devices, the inventive concept is not so limited and is applicable to other types of systems, receivers, or devices. For example, the inventive concept also applies to multicast systems. Likewise, the inventive concept applies to any receiver, or device, for performing power management, with, or without, a battery. As such, the inventive concept applies to a device even if one would consider the device not to be mobile. In addition, although the inventive concept was described in the context of a device comprising a number of elements, it should be realized that the inventive concept also applies to a device where one or more of the elements are arranged in a distributed fashion, e.g., across a network, such as a local area network, bluetooth network, etc. Further, although power management was described in the context of turning on and off FLUTE channels and/or a DVB-H radio receiver, other approaches could also be used. For example, one, or more, integrated circuits in the receiver may support a power saving mode that can be enabled in accordance with the principles of the invention. Or, some or all parts of the receiver can be powered-down, or turned-off, e.g., transceiver circuitry of the receiver (i.e., both the transmitter and receiver). In addition, the inventive concept can be used with other power saving techniques. For example, power management in accordance with the principles of the invention operates in conjunction with the time-slicing module, provided by DVB-H, which aims to save receiver power consumption (e.g., see the earlier-mentioned ETSI EN 302 304 V1.1.1). Also, although described in the context of file-based content transmission the inventive concept is also applicable to real-time content transmissions.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIGS. 7-8, 10, 13, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a receiver, the method comprising:
determining a time delay as a function of a transmission time and a reception time when receiving an event; and
determining a time estimate for receiving a selected event as a function of the time delay.

2. The method of claim 1, wherein the transmission time is a start time for the event.

3. The method of claim 1, wherein the transmission time is an end time for the event.

4. The method of claim 1, further comprising the step of:
performing power management as a function of the determined time estimate.

5. The method of claim 4, wherein the performing power management step includes the step of:
reducing power at a time different from the time estimate for receiving the selected event.

6. The method of claim 5, wherein the reducing power step includes the step of:
controlling at least one of a radio receiver and a packet processor during the at least one time interval such that at least one of the radio receiver and the packet processor operates at reduced power.

7. The method of claim 6, wherein the packet processor supports File Delivery over Unidirectional Transport (FLUTE) sessions and the controlling step includes the step of:
turning off FLUTE channels associated with unselected events when the packet processor operates at reduced power.

8. The method of claim 1, wherein the selected event is representative of file-based content comprising at least one clip.

9. The method of claim 1, wherein the selected event is representative of real-time content comprising at least one program.

10. The method of claim 1, wherein the event is also a selected event.

11. The method of claim 1, wherein the determining a transmission time includes the steps of:
identifying from a program guide a start time of the event as the transmission time.

12. The method of claim 11, wherein the start time is a published start time.

13. The method of claim 1, wherein the determining a reception time includes the steps of:
detecting that received information corresponds to the event; and
recording a time of arrival of the received information as the reception time.

14. The method of claim 13, wherein the detecting step includes the step of:
receiving a File Description Table (FDT) having a Transport Object Identifier (TOI) value that is associated with the event; and
detecting the TOI value in the received information for determining that the received information corresponds to the event.

15. The method of claim 13, wherein the transmission time is a start time and the determining a time delay step determines the time delay by subtracting the start time from the reception time.

16. The method of claim 13, wherein the transmission time is a start time and the determining a time delay step determines the time delay from a statistical function operating on a difference between the start time and the reception time over a period of time for a plurality of events.

17. The method of claim 1, wherein the determining the time estimate step includes the step of:
determining a transmission time for the selected event; and
adding the transmission time for the selected event to the time delay to determine the time estimate for receiving the selected event.

18. The method of claim 1, wherein the determining a transmission time includes the steps of:
identifying from a program guide an end time of the event as the transmission time.

19. The method of claim 18, wherein the end time is a published end time.

20. The method of claim 1, wherein the determining a reception time step includes the steps of:
detecting that received information corresponds to the event; and
recording an actual end time upon completion of receiving the event.

21. The method of claim 20, wherein the transmission time is an end time and the determining a time delay step determines the time, delay by subtracting the end time from the actual end time.

22. The method of claim 20, wherein the transmission time is an end time and the determining a time delay step determines the time delay, from a statistical function operating on the difference between the end time and the actual end time over a period of time for a plurality of events.

23. Apparatus comprising:
a demodulator for providing a received signal representing information conveyed in a sequence of packets;
a packet processor for operating on the received signal for use in recovering the information; and
a processor for determining a time estimate for receiving selected information, wherein the processor determines the time estimate as a function of a time delay, which is determined as a function of a transmission time for received information and a reception time for the received information.

24. The apparatus of claim 23, wherein the transmission time is a start time for the received information.

25. The apparatus of claim 23, wherein the transmission time is an end time for the received information.

26. The apparatus of claim 23, wherein the received information is also the selected information.

27. The apparatus of claim 23, wherein the processor controls at least one of the packet processor and the demodulator such that power is reduced at a time different from the time estimate for receiving selected information

28. The apparatus of claim 27, wherein the packet processor supports File Delivery over Unidirectional Transport (FLUTE) sessions and the processor turns off FLUTE channels associated with unselected information for operating the packet processor at reduced power.

29. The apparatus of claim 23, wherein the selected information is file-based content comprising at least one clip.

30. The apparatus of claim 23, wherein the selected information is real-time content comprising at last one program.

31. The apparatus of claim 23, wherein the transmission time is a start time and the processor determines the time delay as a function of a start time for the received information and an actual time of arrival for the received information.

32. The apparatus of claim 31, wherein the start time of the received information is determined from a program guide.

33. The apparatus of claim 32, wherein the start time is a published start time.

34. The apparatus of claim 31, wherein the time delay is determined by subtracting the start time from the actual time of arrival.

35. The apparatus of claim 31, wherein the time delay is determined from a statistical function operating on the difference between the start time and the actual time of arrival over a period of time for received information.

36. The apparatus of claim 23, wherein the time estimate is determined by adding a transmission time for the selected event to the time delay.

37. The apparatus of claim 23, wherein the transmission time is an end time and the processor determines the time delay as a function of an end time for the received information and an actual time of completion for the received information.

38. The apparatus of claim 37, wherein the end time of the received information is determined from a program guide.

39. The apparatus of claim 38, wherein the end time is a published end time.

40. The apparatus of claim 37, wherein the time delay is determined by subtracting the end time from the actual time of completion.

41. The apparatus of claim 37, wherein the time delay is determined from a statistical function operating on the difference between the end time and the actual time of completion over a period of time for received information.
